(19) United States
(12) Patent Application Publication
(10) Pub. No.: US 2003/0122266 A1
(43) Pub. Date: Jul. 3, 2003

(54) Atomizing device

(76) Inventors: Michael Nau, Dornhan/Aischfeld (DE); Manfred Ruoff, Moeglingen (DE); Marc Bareis, Markgroeningen (DE); Frank Ilgner, Karlsruhe (DE); Horst Harndorf, Schwieberdingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/181,699

(22) PCT Filed: Jan. 17, 2001
(86) PCT No.: PCT/DE01/00170

(30) Foreign Application Priority Data
Jan. 19, 2000 (DE) 100 02 004.6

(51) Int. Cl. B01F 3/04

(52) U.S. Cl. 261/18.1; 261/66; 261/78.2; 261/117

(57) ABSTRACT

The invention relates to an atomizing device for a gas/fluid mixture, in particular for introduction into a chemical reformer for generating hydrogen, which contains at least one gas supply line for supplying a gas flow (11, 11a, 21) and at least one fluid supply line (16, 18) for supplying a fluid flow (17, 19). The fluid supply line (16, 18) feeds at an outlet point (16a, 18a) into a venturi tube (12) that is situated in the gas supply line.

The invention relates to an atomizing device as generically defined by the preamble to claim 1.

### PRIOR ART

Among the alternative drive concepts for motor vehicles, increased attention is currently being focused primarily on fuel cell-supported systems. These systems customarily contain PEM fuel cells (PEM: Polymer Electrolyte Membrane), which are driven using hydrogen and air as energy sources.

Since the refueling and storage of hydrogen in the motor vehicle is still problematic, the hydrogen is produced “on board” as needed from readily available fuels such as methanol, methane, diesel, or gasoline in a preceding reformer stage and is consumed immediately. The reformers used for this are chemical reactors, which are used to partially oxidize the fuels, through the addition of air and moisture, for example at 800° C. in heated catalytic converters, to produce hydrogen and other descendants such as CO and CO₂.

In this connection, the charging of the reformer with the educts required for the reaction is of great importance. Customarily, all of the educts, such as air, water, and fuel are supplied to the reformer in a gaseous state. This requires a pre-atomizer, which is capable of supplying the appropriate quantities of gaseous fuel and water vapor.

During the cold starting phase, however, problems arise because the fluid educts cannot be atomized by the waste heat of the reformer, but only by means of an electrically heated atomizer. Also when there are abruptly changing load alternation demands, conventional atomizers are incapable of instantaneously generating the appropriate quantities of gaseous reactands.

Alternatively, designs have therefore been developed to inject fuels and water directly into the reformer in fluid form. However, in order to assure the most optimal possible reaction behavior in the reformer, the fluid educts must be furnished to the reformer in a finely dispersed form. U.S. Pat. No. 3,971,847 describes a reactor for producing hydrogen, which contains a nozzle that is used to inject fluid hydrocarbons into an airflow. The mist produced is swirled by baffles before it arrives in the actual reaction zone. The water required for the reaction, however, is atomized separately in a pre-atomizer.

The object to be attained is comprised in providing an atomizing device for simultaneously atomizing water and fluid fuels, where the atomizing device should assure a very high degree of atomization and mixture of the educts and moreover an instantaneous metered addition of the fluid educts.

### ADVANTAGES OF THE INVENTION

The atomizing device, with the features disclosed in the independent claims, has the advantage that a gas/fluid mixture is generated, which is distinguished by means of a high degree of atomization and a favorably thorough mixture of the reactands. Moreover, a favorable cold starting behavior of the system and an adequate capacity to react to dynamic load alternation are assured.

The high degree of atomization is achieved by virtue of the fact that the fluid to be atomized is conveyed into a venturi tube through which a gas flow passes and is injected into the gas flow counter to its flow direction. In the vicinity of the outlet opening of the fluid supply line, the gas flow has a high flow velocity, which further increases the atomizing action. Since the atomizing device preferably contains a number of fluid supply lines, the respectively required mixture quantity and composition can be supplied according to the operating state of the reformer.

Due to the purely gas-supported atomization of fluids, only low fluid pressures are required and the installation of expensive high-pressure pumps can be eliminated.

Advantageous modifications and improvements of the atomizing device disclosed in the independent claims are possible by means of the measures taken in the dependent claims.

In a particularly advantageous embodiment, the first venturi tube is disposed inside a gas tube, which constitutes a second venturi tube. The first venturi tube is designed so that the portion of the gas flow passing through it has a high flow velocity at the outlet opening of the fluid supply line. Since the predominant portion of the gas flow passes by the first venturi tube as a remainder gas flow, hardly any throttle losses occur.

It is advantageous to dispose the first venturi tube inside the second so that the outlet side opening of the first venturi tube is situated in the vicinity of the smallest cross section of the second venturi tube since the remainder gas flow passing by the first venturi tube has the greatest flow velocity in this region and in this manner, the gas/fluid mixture emerging from the first venturi tube is homogeneously distributed in the overall gas flow.

An advantageous modification is comprised in placing the second venturi tube inside another gas tube, which constitutes a third venturi tube. This intensifies the above-described phenomenon of an effective atomization with low throttle losses. The second venturi tube is preferably disposed inside the third so that its outlet side opening is situated in the vicinity of the smallest cross section of the third venturi tube.

### DRAWINGS

An exemplary embodiment of the invention is shown in the drawings and will be explained in detail in the subsequent description.

FIG. 1 shows a cross section through a first exemplary embodiment of the atomizing device according to the invention,

FIG. 2 shows a cross section through a second exemplary embodiment, and

FIG. 3 shows a cross section through a spring-assisted check valve provided at the outlet opening.

### EXEMPLARY EMBODIMENTS

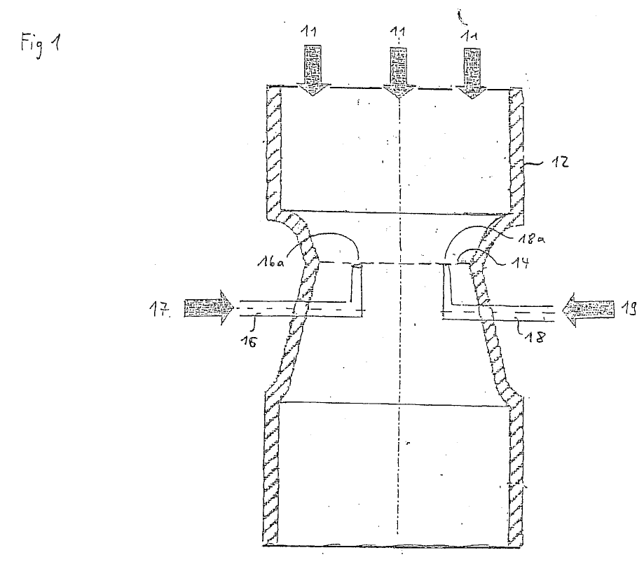

The atomizing device shown in FIG. 1 contains a first venturi tube 12, which a gas flow 11 passes through. In the vicinity of the smallest cross section 14 of the first venturi tube 12, which is also referred to as the throat cross section, at least one, preferably two, fluid supply lines 16, 18 feed into the gas flow 11. These introduce the fluid flows 17 and 19 into the gas supply line and feed into the gas flow 11 at the outlet openings 16a and 18a. The fluid supply line 16, 18 here passes through the outer wall of the first venturi tube 12 largely at right angles and has a preferably 90° bend inside the venturi tube 12 so that the outlet opening 16a, 18a is directed counter to the flow direction of the gas flow 11. The fluid flow 17, 19 transported by the fluid supply line 16, 18 likewise enters the first venturi tube 12 counter to the flow direction of the gas flow 11. Since the outlet opening 16a, 18a is situated in the vicinity of the throat cross section 14 of the venturi tube 12, the fluid is entrained by the very high flow velocity of the gas flow 11 at this point and is atomized.

The gas flow 11 is essentially composed of the gaseous educts of the reformer and above all, contains air, water vapor, or also gaseous fuels. These can be mixed already before entry into the atomizing device according to the invention; however, it is also possible to supply the water vapor and gaseous fuels to the gas flow 11 only after departure from the atomizing device. Water and fluid fuels such as gasoline, diesel, methanol, methanol/water mixtures, or gasoline/water emulsions are supplied to the atomizing device as fluid educts. Since the atomizing device preferably contains more than one fluid supply line 16, 18, the fluid educts can be atomized in the gas flow 11 either individually or mixed together.

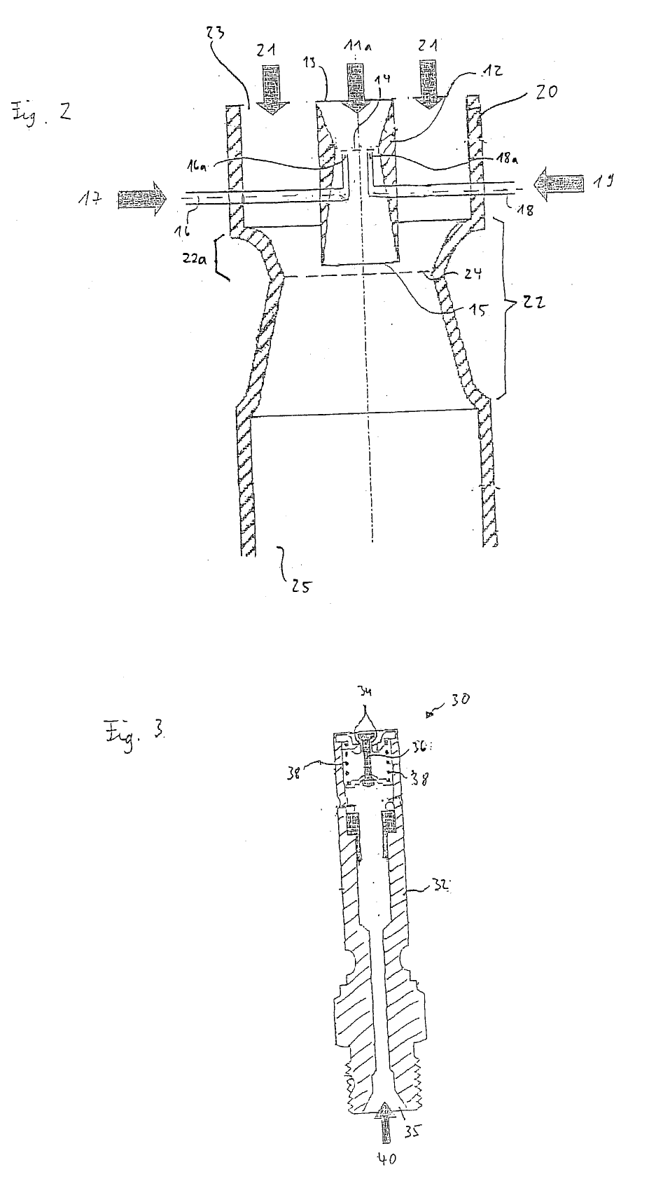

FIG. 2 shows a second exemplary embodiment of the atomizing device according to the invention. The first venturi tube 12 is disposed inside a gas tube 20, which the partial gas flow 11a and the remainder gas flow 21 pass through. The gas tube 20 has a second venturi tube 22.

In the case of a first variant of the second exemplary embodiment shown in FIG. 2, the entry side opening 13 of the first venturi tube 12 is positioned inside the gas tube 20 so that upon entry into the first venturi tube 12, the partial gas flow 11a has a flow velocity comparable to that of the remainder gas flow 21. For example, the first venturi tube 12 is embodied so that its profile and cross sectional reduction produces a significantly higher flow velocity of the partial gas flow 11a than the embodiment of the second venturi tube 22 produces in the remainder gas flow 21. The increased flow velocity of the partial gas flow 11a in the vicinity of the outlet opening 16a, 18a intensifies the favorable atomizing action of the device according to the invention, but higher flow velocities always also result in higher throttle losses. However, since these only occur in the partial gas flow 11a, which is relatively insignificant in terms of volume, they can be disregarded.

A second variant, not shown, of the exemplary embodiment shown in FIG. 2 is produced if in terms of the flow direction of the remainder gas flow 21, the entry side opening 13 of the first venturi tube 12 is not disposed before the region of the gas tube 20 embodied as a venturi tube 22, but inside it, in the vicinity of the cross sectional reduction 22a of the second venturi tube 22.

Since both gas flows 11a, 21 already have a distinctly increased flow velocity at this point, in the vicinity of the throat cross section 14 of the first venturi tube 12, even higher flow velocities occur in the partial gas flow 11a than in the above-described first variant of the exemplary embodiment shown in FIG. 2. The atomizing action of the device is thus further optimized without increasing the throttle losses to any appreciable degree.

In both variants of the second exemplary embodiment, the outlet side opening 15 of the first venturi tube 12 is positioned inside the gas tube 20 so that the opening is situated in the vicinity of the throat cross section 24 of the second venturi tube 22. A position situated a few millimeters before the throat cross section 24 in the flow direction of the remainder gas flow 11a is particularly advantageous. In this region, the remainder gas flow 21 reaches its highest flow velocity, as a result of which the fluid-charged partial gas flow 11a is distributed homogeneously in the remainder gas flow 21.

A third exemplary embodiment, which is not shown here for the sake of clarity, is based on the second exemplary embodiment shown in FIG. 2. It has an additional gas tube, which also constitutes a third venturi tube and contains the first gas tube 20. The outlet side opening 25 of the gas tube 20 is disposed inside the additional gas tube so that it is situated in the vicinity of the throat cross section of the third venturi tube.

Logically, in this third exemplary embodiment, several variants are conceivable in terms of the position of the entry side opening 23 of the first gas tube 20 inside the additional gas tube or of the first venturi tube 12 inside the second venturi tube 22, which are based on the variants of the second exemplary embodiment. Embodiments with four or more venturi tubes nested inside one another are also conceivable.

The outlet openings 16a, 18a are embodied, for example, as check valves so that they have an injecting action on the fluid supplied via the fluid supply line 16, 18 and also prevent a subsequent leakage of the fluid.

An exemplary embodiment of a check valve 30 of this kind is shown in FIG. 3. The check valve 30 is embodied, for example, as a screen flow valve, but perforated flow valves or other conventional valve types are also suitable. In a housing 32, which has an outlet side opening 34, the check valve 30 has a needle seat 36, which is connected to the housing 32 by means of tension or compression springs 38. The needle seat 36 closes the outlet side opening 34 and only when there is a corresponding fluid pressure of the fluid flow 40 supplied via a supply line side opening 35, does this needle seat 36 permit the fluid to escape into the gas flow surrounding the check valve 30. It is particularly advantageous to dimension the check valve 30 so that its needle seat 36 is kept in an oscillating state between an open and closed position because this causes the emerging fluid flow 40 to be scrambled and intensifies the atomizing action of the atomizing device. This occurs through the selection of an appropriate oscillation mass and spring constant, which produces an oscillating spring-mass system.

All of the components of the atomizing device are made, for example, of stainless steel, but other stable and corrosion-proof materials can also be used.

In order to generate the hydrogen in the subsequent reformer, various educt mixtures can be used, depending on the requirements. Thus hydrogen can be obtained through partial oxidation of fuels through the alternative addition of water vapor, air, or a mixture of the two. The conversion usually occurs in a catalytic converter that can be heated and fuels such as gasoline, diesel, methane, or methanol can be used. Furthermore, methanol/water mixtures or gasoline/water emulsions are also suitable in this regard.

Depending on the load requirements of the fuel cell, it is necessary to differentiate among different operating states of the reformer or the overall system. Even with changing operating states, the atomizing device according to the invention is always able to supply the system with the required quantities and compositions of the necessary educts.

Under stationary operating conditions, the reformer must be supplied with air and/or water vapor. Air and water vapor can be supplied to the reformer either in a premixed form or as largely separate gas flows. For example, the fluid fuel is supplied to the atomizing device via the fuel supply line 16 and arrives in the reformer in a finely dispersed form. Depending on the operating state of the reformer, the atomizing device can also be used to supply the system with water via the fluid supply lines 18. This is important primarily when there are abrupt load alternations. It is also possible to supply the atomizing device with fuel/water mixtures.

During the cold starting phase of the system, there is no water vapor available and the water is supplied to the reformer in fluid form. The high degree of atomization of the gas/fluid mixture generated by the atomizing device according to the invention produces a considerable acceleration of the starting process. In addition, the starting behavior can be further improved by means of a heated catalytic converter in the reformer.

If the atomizing device according to the invention is coupled to a corresponding metering system for the gaseous and fluid educts, then this results in an advantageous spatial separation of the metering and atomization. This is significant primarily if the atomizing device is integrated into the reactor wall of the reformer since if the metering valves were close in spatial distance to the reformer, they would require cooling, which would be costly.

The atomizing device according to the invention is not limited to the exemplary embodiments described; other embodiments of an atomizing nozzle are conceivable, which are based on a gas flow-supported atomization and in which, for example, the fluid flow 17, 19 travels into the venturi tube 12 in the flow direction of the gas flow 11.

1. An atomizing device for a gas/fluid mixture, in particular for introduction into a chemical reformer for generating hydrogen, with at least one gas supply line for supplying a gas flow and at least one fluid supply line for supplying a fluid flow, the fluid supply line feeding into the gas supply line at an outlet point, characterized in that a first venturi tube (12) is provided, which the gas flow (11, 11a) of the gas supply line passes through, and that the outlet point (16a, 18a) feeds into the first venturi tube (12) in the vicinity of the smallest diameter (14).

2. The atomizing device according to claim 1, characterized in that the first venturi tube (12) is disposed at least partially inside a gas tube (20) that the gas flow (11a, 21) of the gas supply line passes through.

3. The atomizing device according to claim 2, characterized in that the gas tube (20) constitutes a second venturi tube (22) in the vicinity of the venturi tube (12).

4. The atomizing device according to at least one of claims 1 to 3, characterized in that the first venturi tube (12) is disposed inside the second venturi tube (22) so that the outlet side opening (15) of the first venturi tube (12) is situated in the vicinity of the smallest diameter (24) of the second venturi tube (22).

5. The atomizing device according to claim 3 or 4, characterized in that the gas tube (20) is disposed at least partially inside another gas tube of greater diameter, which the gas flow (11a, 21) of the gas supply line passes through.

6. The atomizing device according to at least one of claims 1 to 5, characterized in that the additional gas tube constitutes a third venturi tube in the vicinity of the second venturi tube (22).

7. The atomizing device according to claim 6, characterized in that the second venturi tube (22) is disposed inside the third venturi tube so that the outlet side opening of the second venturi tube (22) is situated in the vicinity of the smallest diameter of the third venturi tube.

8. The atomizing device according to at least one of claims 1 to 7, characterized in that water and/or a fuel can be supplied as fluids.

9. The atomizing device according to at least one of claims 1 to 7, characterized in that at least one first fluid supply line (16) is provided for a fuel and/or at least one second fluid supply line (18) is provided for water.

10. The atomizing device according to at least one of claims 1 to 9, characterized in that the outlet point (16a, 18a) is disposed inside the first venturi tube (12) so that the opening of the outlet point (16a, 18a) points counter to the flow direction of the gas flow (11, 11a).

11. The atomizing device according to at least one of claims 1 to 10, characterized in that a spring-assisted check valve (30) is provided in the fluid supply line (16, 18) in order to prevent a subsequent leakage of the fluid.

12. The atomizing device according to claim 10, characterized in that the spring-assisted check valve (30) is designed as an oscillating spring-mass system.

13. The atomizing device according to at least one of claims 1 to 12 for atomizing fluid educts of a reformer for fuel cells.
